(19) United States
(12) Patent Application Publication
(10) Pub. No.: US 2026/0105488 A1
(43) Pub. Date: Apr. 16, 2026

(54) DATA ATTRIBUTION PIPELINE

(71) Applicant: FOURSQUARE LABS, INC., New York, NY (US)

(72) Inventors: Vikram Gundeti, Sammamish, WA (US); Kumar Somnath, Seattle, WA (US); Alexey Sviyazov, Rye, NY (US)

(21) Appl. No.: 19/358,105

(22) Filed: Oct. 14, 2025

Related U.S. Application Data
(60) Provisional application No. 63/707,097, filed on Oct. 14, 2024.

(51) Int. Cl. G06Q 30/0242

(52) U.S. Cl. CPC G06Q 30/0246

(57) ABSTRACT

Aspects of the present disclosure provides systems and methods that analyze data transmissions and location data to measure and optimize data distribution campaigns’ effectiveness in driving foot traffic to venues in real-time. For example, data related to impression events can be received from a distributed set of data stores and/or distributed using different data networks. Subsequently, location information can be analyzed to determine visits to venues associated with the impression event. In further embodiments, data can be collected from different transaction sources and associated with impression events and location information. The collected data can be normalized and segmented to determine the effectiveness of the impression event.

### CROSS REFERENCE TO RELATED APPLICATIONS

This application claims priority to U.S. Provisional Patent Application No. 63/707,097, filed on October 14, 2024, the disclosure of which is hereby incorporated by reference in its entirety.

### BACKGROUND

In today’s complex digital landscape, understanding the true impact of omnichannel campaigns is crucial for data distributors. It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure provides systems and methods that analyze data transmissions and location data to measure and optimize data distribution campaigns’ effectiveness in driving foot traffic to venues in real-time. For example, data related to impression events can be received from a distributed set of data stores and/or distributed using different data networks. Subsequently, location information can be analyzed to determine visits to venues associated with the impression event. In further embodiments, data can be collected from different transaction sources and associated with impression events and location information. The collected data can be normalized and segmented to determine the effectiveness of the impression event.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary attribution pipeline process, also referred to herein as an attribution pipeline, for aggregating and analyzing data across various data sources to score an impression event.

FIG. 2 depicts a conceptual example of projection algorithm.

FIG. 3 depicts exemplary metrics for measuring the effectiveness of an impression event.

FIG. 4 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Aspects of the present disclosure provides systems and methods that analyze data transmissions and location data to measure and optimize data distribution campaigns’ effectiveness in driving foot traffic to venues in real-time. For example, data related to impression events can be received from a distributed set of data stores and/or distributed using different data networks. Subsequently, location information can be analyzed to determine visits to venues associated with the impression event. In further embodiments, data can be collected from different transaction sources and associated with impression events and location information. The collected data can be normalized and segmented to determine the effectiveness of the impression event. For example, if a fast-food chain runs a campaign to promote a new menu item, aspects of the present disclosure provide a technical solution that can analyze multiple different data streams and/or data stores to determine whether the campaign is driving an increase in foot traffic, in which geographies, and through which channels.

The technical challenges to provide this functionality are significant, as the consumer journey has become increasingly complex, with seamless transitions between online shopping, in-store visits, and hybrid options like ordering for in-store pickup. Recognizing this, the disclosed attribution system incorporates sales impact features, which was previously not available to other attributions solutions as the sales impact features are generally stored in inaccessible data stores and/or in data formats not generally supported by existing solutions. By integrating transaction data with location information (i.e., visitations, foot traffic, etc. acquired via mobile devices, for example), aspects of the present disclosure provide a comprehensive analysis of data from various, different systems (i.e., mobile devices, third-party servers and/or services, point of sale systems, e-commerce applications, etc.). In doing so, aspects of the present disclosure are operable to track not just increased foot traffic but also resulting sales, providing a more accurate picture of how a data impression is associated with subsequent transactions and movements. That is, aspects of the present disclosure relate to a location, data, and transaction tracking and analysis system.

Connecting foot traffic to sales data is not a trivial matter. Existing data systems must redesign their data processing pipeline foundation and to introduce enhancements to tracking methodologies and checkpoints across a data pipeline to ensure the metrics are generated in a timely, reliable, and accurate manner. Aspects of the present disclosure provide an enhanced pipeline that, in addition to providing other benefits, accomplish these objectives.

Aspects of the present disclosure provide an attribution pipeline that matches exposure events (also known as data impressions) to physical visitations and transactions and generates analysis data that provide insights into behaviors that can be attributed back to an exposures event. Initially, the attribution pipeline is integrated with data impression services to configure omni-channel campaigns that are measured by the attribution pipeline. These omni-channel campaigns can be for a nationwide chain, specific regions, or a specific subset of venue locations. Once the omni-channel campaign is configured and executed, exposure data is retrieved by the disclosed attribution pipeline.

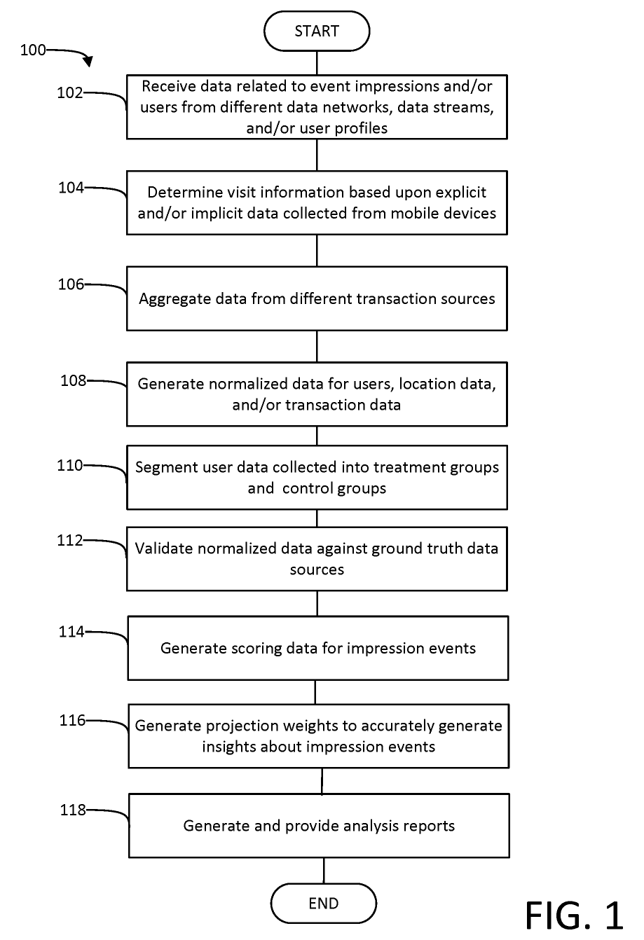

FIG. 1 depicts an exemplary attribution pipeline process 100, also referred to herein as an attribution pipeline, for aggregating and analyzing data across various data sources to score an impression event. Receipt of the exposure data triggers the processing pipeline, which comprises the following steps: input generation, normalization, matching, scoring, and projection.

Input generation operation 102 may include different receiving different inputs, such as impression input, visit input, and transaction input. In aspects, direct digital impressions can be captured through a HTTP “Pixel” endpoint, which tracks user exposures in real time. For non-digital impressions, impression data can be via secure file transfer protocol (SFTP) or other data transfer protocols, such as, but not limited to S3. Alternatively, or additionally, aspects disclosed herein are operable to infer impressions from other datasets. For example, in the case of television impressions, the attribution pipeline is operable to infer impressions by monitoring or acquiring viewership data. Viewership data can be analyzed to determine who was watching and when and cross-referenced with impression logs that indicate what impressions were being shown at those times. For out-of-home (OOH) impressions, OOH impressions are tracked by joining movement data (determined actively or passively based upon data received from a mobile device) with the location of the of the OOH impressions, such as billboards, signs on public transportation, etc. Impressions, regardless of the source, are canonicalized to a common format. The canonicalized impressions contain information about users that were exposed, when the exposure occurred, and which campaign is this impression a part of. In certain examples, additional metadata may be tagged to each impression, which captures other information about the impressions, such as the media type used, and the segment targeted, etc.

### Visits

At operation 104, visit information is determined. The disclosed attribution pipeline’s ability to precisely measure a store visit in the physical world is made possible by a comprehensive Places dataset, Stop Detection technology and Snap-to-Place algorithms trained on ground truth generated from our consumer apps. For example, the attribution pipeline processes GPS pings from a combination of first person and carefully vetted third person sources to ensure privacy protection, secure the data collected, and perform data transformations used to determine accurate and precise location information.

The attribution pipeline may comprise or exchange data with a places engine (as disclosed in copending U.S. Application Serial No. 19/358,011, entitled “Artificial Intelligent Agent Crowdsourcing” filed on October 14, 2025, the entirety of which is hereby incorporated by reference) that employes machine learning and/or crowdsourcing technology to analyze signals from mobile devices and digital agents to generate highly accurate location data that is continuously refreshed as devices continue to move throughout an area. In examples, the location data is curated from trusted sources and validated by automated processes against publicly available information related to users, impressions and/or entities associated with the impressions, etc., to identify and remove inaccurate visit detection data.

GPS signals from users (collected via mobile device data, application data, etc.) and location data from verified third-party partners is aggregated. A stop detection algorithm analyzes the aggregated locations data to identify clusters of GPS signals that indicate a certain dwell time at a specific location, which, upon reaching or surpassing a threshold amount of time, can be used to identify a stop. The stop data is used to capture true visits at a venue, as opposed to someone driving by or sitting in traffic near a venue.

Detecting a visit to a place from the GPS coordinates of a stop point may seem like a trivial task, especially if the approach is to predict a visit based on the proximity of the GPS coordinates recorded by a mobile device to that place. However, this approach is inherently flawed as it does not acknowledge the erroneous nature of the GPS signals. For instance, a user operates their mobile device in a dense location, more often than not, it shows the user as being located on the other side of a road or in an adjacent building.

Thus, merely using GPS signal to record visits with a proximity radius, the resulting visits are often inaccurate. Instead, in addition to the GPS signals, aspects of the present disclosure uses a variety of signals, such as the time of the day, the categories of the places nearby, user history data, social media data, etc., and leverages the ground truth data (e.g., explicit data such as check-ins via a mobile app) to build a model to predict visits. This model is then used to accurately predict visits from the stop points. This model can be further augmented through the use of verified third-party data. The accuracy and quality of third-party data is confirmed by comparing the pings of overlapping users with our first-party and explicit data.

### Transactions

At operation 106, transaction data may be aggregated and analyzed from various different transaction sources. The attribution pipeline can be integrated with transaction data, for example, data obtained from point-of-sale systems, network transactions, e-commerce website data, credit card payment data, etc. The attribution pipeline ingests transaction data and analyze the transaction data to correlate transaction data with location visits. It is not a simple task to map transactions to location data. Transactions have information encoded about them in particular data formats, for example, as fuzzy string data. This makes it challenging to accurately determine the place at which the transaction was recorded. To overcome this technical hurdle, the attribution pipeline analyzes transaction data not only in isolation, but also analyzes patterns in a series of transactions from each transaction data source to accurately identify places where they occurred. As a result, a transaction string with very little information such as “SPEEDWAY 09582 CINCINNATI CINCINNATI OH” can be accurately mapped to “Speedway 2713 Williams Ave Cincinnati OH 45209”, even though there are multiple Speedways in Cincinnati.

### Normalization

At operation 108, one or mor data normalization processes are performed. Normalization is the process through which the attribution pipeline scales visitation and transaction behaviors observed within a subset of users to reflect a real-world population. This sets the baseline for campaign-specific impact calculations. Normalization involves eliminating inherent data biases, such as demographic bias, behavioral bias and also ensuring that the analysis performed by the attribution pipeline maintains a consistent membership of users in a panel.

### Ensuring a Stable Panel: Tenure Filters

While our first-party visitation panel and our transaction panel are generally consistent, third-party visitation data tenure can vary. To eliminate inaccuracies arising from panel members whose activity only appears sporadically within the panel, the attribution pipeline first filters out data related to users who do not have consistent activity over time.

### Eliminating Demographic Bias: Census Weights

Imagine a hypothetical scenario where a panel has 70% male users and 30% female users, but in observation the actual population is evenly split 50/50. The attribution pipeline is operable to execute a weighting algorithm that adjusts the importance of each user’s data to address such discrepancies. In this hypothetical, algorithm would adjust the weights of data such that the female users’ data is given more weight, effectively balancing out the gender representation. That is, the algorithm is operable to analyze the retrieved panel data against known data conditions to adjust weights in a manner that allows the retrieved data to more accurately resemble the known data characteristics. Continuing with the example, this means that in this hypothetical analysis, the behavior of a female user might be counted as 1.67 times as important as a male user’s behavior, ensuring our overall results reflect a 50/50 gender split. As such, the attribution engine is operable to use census weighting to eliminate demographic bias in collected data.

In examples, trusted sources of data may be used to generate weights for panel data, for example, by comparing panel data to government-published census information at a census block group level. The attribution pipeline identifies the users in the panel belonging to a census block group using an identification algorithm, predicts their demographics from their visitation/purchase behavior, and then modify by the appropriate weights to eliminate the bias. Then, the panel information is further weighted to reflect the overall population.

### Eliminating Behavioral Bias: Place weights

The attribution engine is also operable to analyze data and correct for behavioral biases in panel data related to visitation and purchase patterns based on venue location. For instance, in an example where panel data shows a disproportionately high number of visits to coffee shops for panel users compared to the general population. If panel users visit coffee shops twice as often as the average person, the attribution engine would compare the differences between panel visits and general visits to generate a weight to coffee shop visits for panel members, thereby adjusting panel data to be in line with the general population’s visit behavior. To achieve this, the attribution pipeline utilizes transaction data and first-party visitation data (e.g., explicit and implicit data collected from mobile devices) to determine trends and validate panel data against publicly verifiable information.

### Validating Against Ground Truth Data

At operation 110, the normalized data is validated. For example, the data may be validated against data from a trusted source. Normalized data can be routinely tested to ensure that the normalized output is aligned with ground truth data from trusted sources. First, the attribution pipeline validates that the trends in the scaled-up transactions corresponding to various impression events, products, and or venues are aligned with data in public financial statements associated with corresponding entities. Second, the attribution engine ensures that the trends in the visitation panel align appropriately with the transaction trends for different, but related entities and categories in order to determine weightings and transformations to align collected data samples with real-world behavior verified by ground truth data sources.

### Matching

Matching operation 112 is a process through which the attribution pipeline segments the user data collected in the panels into treatment and control groups based on whether or not they are exposed to an impression event and identifies a modeled twin cohort for users in the treatment group with ones in the control group. In examples, the matching operation can be a two-step process.

First, impression event data is joined with panel data to identify a subset of the users in the panel data who have been exposed to the campaign. An identification graph, e.g., a graph data structure, is generated and traversed to map identifiers to the users in the panel data. In examples, the identifiers are unique identifiers that do not contain personally identifiable information (PII). Then, a matching process is executed to match users exposed to the impression event with cohorts of control group users who have not been exposed. The matching process factors in demographic information, geographic area, past visitation behaviors to specific chains and categories, etc. to match exposed and non-exposed cohorts. The attribution pipeline uses these cohorts of mirrored users to measure behavioral differences resulting from the exposure to the impression event. This process allows the attribution pipeline to determine not only the average treatment effect (how the impression event affects all exposed users on average), but also the conditional average treatment effect. For instance, whether a specific coffee campaign is incrementally effective in driving impact with urban dwellers in their thirties who already frequent coffee shops, is baked into the treatment effect.

### Scoring

During the scoring operation 114, a “conversion window” or a defined time period after an impression event is determined during which a venue visit or transaction occurs. A visit and/or transaction event that occurs within the conversion window can be attributed or otherwise associated with the impression event. The length of this window can vary depending on the type of campaign, impression event, venue visited, transaction type, and/or user preferences, but typically ranges from a few days to a few weeks. For each recorded visit and/or purchase, the attribution pipeline compares user impression history data and identify all visits or purchases that fall within the conversion window after an impression is recorded. When multiple impressions share a common conversion window, the attribution engine may use an even-weighting, multi-touch approach to assign equal, fractional credit to all impressions corresponding to the visits or transactions in that period. For example, if a user saw three impression events from the same campaign before visiting a particular venue and/or making a particular purchase, and all three impressions fall within the conversion window, each impression would be credited with 1/3 of the visit and/or purchase.

To determine the incremental impact of the impression event, the attribution pipeline compares the visit or purchase rate of users exposed to ads to a similar group of users who were not exposed. However, this does not paint the complete picture for the campaign, as our panel only represents a subset of the overall population exposed to the campaign. That’s where the Projection step plays a crucial role.

### Projection

At operation 116, a projection weighting operation is performed by the attribution pipeline. Projection weighting may be the final step in the attribution pipeline. The projection weighting is used to generate accurate insights about the entire impression event campaign by weighing the generated scores. For example, a user may employ an omnichannel campaign across two distributors and the hypothetical match rate generated by the attribution pipeline may be as follows:

### Streaming Audio Platform: 1000 total impressions, 100 matched impressions, 10% match rate.

Social Media Platform: 800 total impressions, 50 matched impressions, 6.25% match rate.

At first glance, it seems the streaming audio publisher is outperforming, but this apparent advantage is simply due to a higher match rate with our panel. Prior to the projection weighing operation 116, the data generated by the attribution pipeline overestimate the streaming audio publisher’s impact in the campaign and underestimate the social publisher’s contributions. Moreover, the initially generated data may not account for how users were exposed across channels. Let’s say, we have:

80 matched impressions are from users who saw only Streaming Audio impression events.

40 matched impressions are from users who saw only Social impression events.

30 matched impressions (20 from Streaming Audio, 10 from Social Ads) are from users who saw impression events on both platforms.

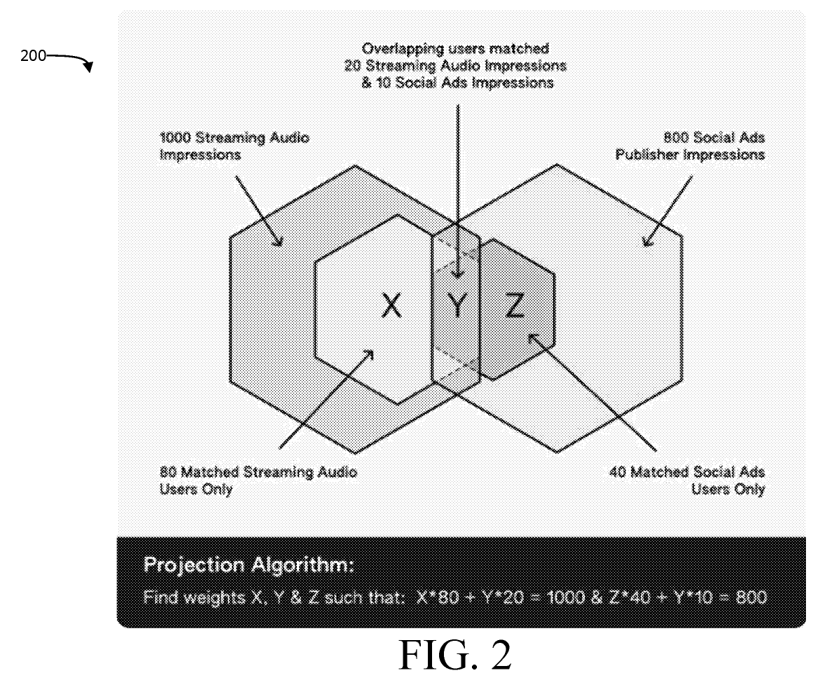

FIG. 2 depicts a conceptual example of projection algorithm 200. Analyzing the impressions and users of these segments allows the attribution pipeline to accurately attribute the impact of each channel while accounting for the overlapping exposure that occurs in multi-channel campaigns. An example of the projection weighting algorithm addresses these challenges using the example in FIG. 2:

The attribution pipeline may initiate the projection weighing operation by analyzing the matched impressions corresponding to the three segments identified above: users who only received Streaming Audio event impressions (80), users who only received Social event impressions (40), and overlapping users who saw event impressions on both platforms (20 on Streaming Audio and 10 on Social).

The projection weighing algorithms generates weights for each such segment such that when the generated weights are applied to the census weighted panelists in that segment, the total weighted impressions of the Streaming Audio channel equal 1000 and those of the Social Ads channel equal 800, in the example. In doing so, the projection weighing algorithms generates the weights in a way to minimize distortion of the original data.

The resulting weights are then applied to each census weighted panelist based on the segment they are a part of, to ensure accurate representation of impression & reach targets while maintaining appropriate demographic and geographic distribution aligned with the campaign’s intended audience. In doing so, the projection weighing algorithm addresses the limitations of the prior data generation and analysis solutions discussed herein.

The calibrated projection weighing operation provides users with a comprehensive view of their campaign’s performance. By extrapolating from matched panelists to the overall campaign, the attribution pipeline ensures fair representation of each channel’s contribution, regardless of varying match rates or partial visibility into total impression event data. In doing so, aspects of the present application maintain the integrity of the campaign’s targeted audience characteristics, enabling the attribution pipeline to deliver attribution reports that truly reflect the full impact and success of omnichannel campaigns via disparate data channels and data sources.

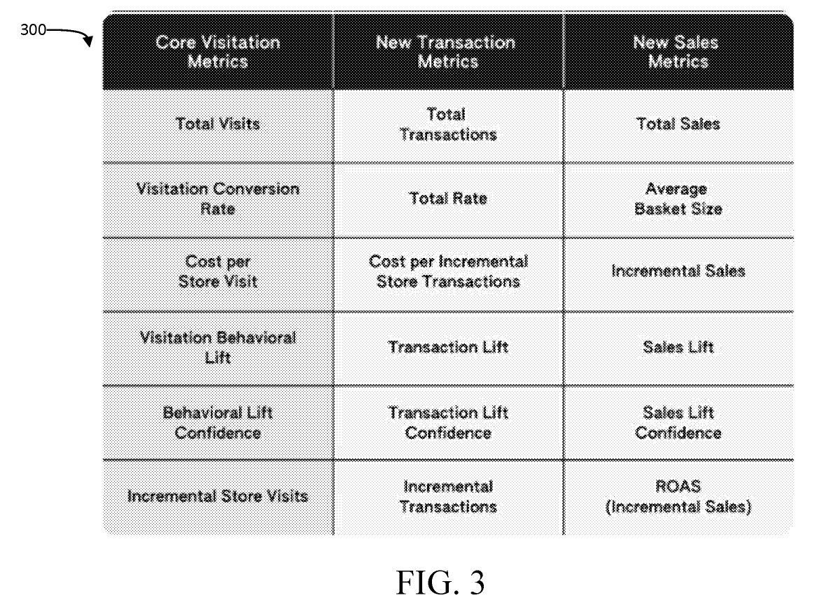

FIG. 3 depicts exemplary metrics 300 generated by the attribution pipeline. The attribution is operable to generate and provide a report, such as in operation 118 of FIG. 1, which includes one or more or the exemplary metrics 300. The reports may be generated and distributed in a data file, an email, displayed on a dashboard accessible via a network, etc. In doing so, the attribution pipeline is operable to provide a comprehensive measurement approach and generate a full-funnel view of event impression impact across various different networks, data channels, data stores, etc., tracking the customer journey from initial impression exposure to final visit and/or transaction. In doing so, the exemplary metrics 300 can be used to generate a model or report detailing a complete understanding of their digital impression event campaigns result in real-world effectiveness.

Exemplary metrics 300 may include core visitation metrics, which quantify foot traffic fundamentals such as total visits, conversion rates, and our proprietary visitation behavioral lift. Building on this foundation, the attribution pipeline generates metrics that provide more robust information, enumerating purchases and quantifying the incremental transactions driven by each impression event campaign. For a thorough financial perspective, the attribution pipeline is integrated with transaction systems to generate sales metrics which, when analyzed in combination with core visitation metrics, generate a report that encompasses total sales, average basket size, and return on ad spend (ROAS). FIG. 3, as such, provides examples of metrics that can be included in attribution reports generated by the attribution pipeline.

In aggregate, these metrics across visitation, transactions, and sales offer a holistic view of an event impression campaign’s influence on the user behavior, extending beyond just driving users to particular venues to capture actual financial outcomes and generated data previously inaccessible due to the data residing on different data networks and different data stores, which often are not interoperable.

The attribution pipeline provides improved data processing capabilities over existing solutions, addressing a critical bottlenecks found in prior systems. More specifically, it could take several days to gather all necessary information for data processing and require a significant amount of time to perform a daily refresh of metrics for all campaigns, preventing existing solutions from using a greater portion of data as it arrived over multiple days. The attribution pipeline, however, can now process visits incrementally, solving this problem. This leap in processing speed translates directly to benefits for data analysis systems and users of said systems, such as, among other benefits, generating more accurate reports and the ability to reach feasibility in smaller geographical areas, and generating more comprehensive and faster insights having expanded geographical reach and enhanced accuracy. As the line between online and offline user behavior continues to blur, the attribution pipelines is operable to connect various different data networks and data stores to generate reports that detail the complex path from event impressions to real-world activities.

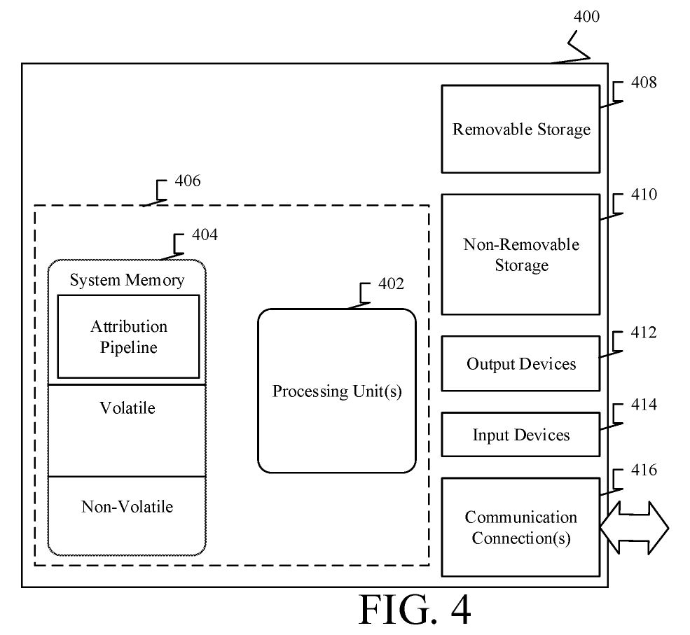

FIG. 4 illustrates a simplified block diagram of a device with which aspects of the present disclosure may be practiced, according to aspects described herein. The device may be a mobile computing device or a VR device for example. One or more of the present embodiments may be implemented in an operating environment 400. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 400 typically includes at least one processing unit 402 and memory 404. Depending on the exact configuration and type of computing device, memory 404 (instructions to perform for performing the aspects disclosed herein) may be volatile (such as RAM), non-volatile (such as ROM, flash memory, etc.), or some combination of the two. This most basic configuration is illustrated in FIG. 4 by dashed line 406. Further, the operating environment 400 may also include storage devices (removable, 408, and/or non-removable, 410) including, but not limited to, magnetic or optical disks or tape. Similarly, the operating environment 400 may also have input device(s) 414 such as remote controller, keyboard, mouse, pen, voice input, on-board sensors, etc. and/or output device(s) 412 such as a display, speakers, printer, motors, etc. Also included in the environment may be one or more communication connections, 416, such as LAN, WAN, a near-field communications network, a cellular broadband network, point-to-point, etc.

Operating environment 400 typically includes at least some form of computer readable media. Computer readable media can be any available media that can be accessed by the at least one processing unit 402 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 400 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for analyzing data from disparate data sources and networks using an attribution pipeline, the method comprising:
receiving data from one or more disparate data sources and data networks;
determine visit information, wherein the visit information is determined based upon data received one or more mobile devices associated with a user base;
aggregate transaction data from a plurality of different transaction sources;
generate normalized data by normalizing visit information, transaction data, and users associated with the visit information and transaction information;
generate an analysis report based upon the normalized data; and
providing the analysis report.

2. The method of claim 1, further comprising generating a plurality of scores for a plurality of impression events based upon the normalized data.

3. The method of claim 2, further comprising generating at least one projection weight, wherein the at least one projection weight is used to generate a weighted plurality of scores based upon the generated plurality of scores.

4. The method of claim 3, wherein generating at least one projection further comprises:
determining a first segment exposed to an impression event on only a first channel;
determining a second segment exposed to the impression event on only a second channel;
determining a third segment exposed to the impression event on both the first channel and the second channel;
calculating weights for the first, second, and third segments by applying such that applying the weights to census-weighted users in each segment causes total weighted impressions for each channel to match respective target impression counts while minimizing distortion of the normalized data.

5. The method of claim 1, wherein the analysis report is provided in a data file.

6. The method of claim 1, wherein the analysis report is provided via a portal accessible via a network.

7. The method of claim 1, further comprising segmenting the normalized data into at least two groups.

8. The method of claim 1, wherein the at least two groups include a control group and a treatment group.

9. A system comprising:
at least one processor; and
memory encoding computer executable instruction that, when executed by the at least two processors, perform a method for analyzing data from disparate data sources and networks using an attribution pipeline, the method comprising:
receiving data from one or more disparate data sources and data networks;
determine visit information, wherein the visit information is determined based upon data received one or more mobile devices associated with a user base;
aggregate transaction data from a plurality of different transaction sources;
generate normalized data by normalizing visit information, transaction data, and users associated with the visit information and transaction information;
generate an analysis report based upon the normalized data; and
providing the analysis report.

10. The system of claim 9, wherein the method further comprises generating a plurality of scores for a plurality of impression events based upon the normalized data.

11. The system of claim 10, wherein the method further comprises generating at least one projection weight, wherein the at least one projection weight is used to generate a weighted plurality of scores based upon the generated plurality of scores.

12. The system of claim 11, wherein the plurality of scores are determined based upon a determined conversion window for one or more impression event of the plurality of impression events.

13. The system of claim 9, wherein the analysis report is provided in a data file.

14. The system of claim 9, wherein the analysis report is provided via a portal accessible via a network.

15. The system of claim 9, wherein the method further comprises segmenting the normalized data into at least two groups.

16. The system of claim 15, wherein the at least two groups include a control group and a treatment group.

17. A non-transitory computer readable medium encoding computer executable instructions that, when executed by at least one processor, perform a method comprising:
receiving data from one or more disparate data sources and data networks;
determine visit information, wherein the visit information is determined based upon data received one or more mobile devices associated with a user base;
aggregate transaction data from a plurality of different transaction sources;
generate normalized data by normalizing visit information, transaction data, and users associated with the visit information and transaction information;
generate an analysis report based upon the normalized data; and
providing the analysis report.

18. The non-transitory computer readable medium of claim 17, wherein the method further comprises generating a plurality of scores for a plurality of impression events based upon the normalized data.

19. The non-transitory computer readable medium of claim 18, wherein the method further comprises generating at least one projection weight, wherein the at least one projection weight is used to generate a weighted plurality of scores based upon the generated plurality of scores.

20. The non-transitory computer readable medium of claim 19, wherein the plurality of scores are determined based upon a determined conversion window for one or more impression event of the plurality of impression events.
